(19) United States
(12) Patent Application Publication
(10) Pub. No.: US 2006/0096582 A1
(43) Pub. Date: May 11, 2006

(54) Counter-balanced inlet door for fuel pump module check valve

(76) Inventors: Patrick Powell, Farmington Hills, MI (US); William Attwood, Windsor (CA); Akiyoshi Mukaidani, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 10/983,930

(22) Filed: Nov. 8, 2004

(51) Int. Cl. F02M 37/00

(52) U.S. Cl. 123/514

(57) ABSTRACT

In a fuel pump module of a vehicle fuel tank, a check valve has a counter-balanced inlet door that uses a counterweight to assist in opening the inlet door to control the flow of fuel into and out of the jet pump tube of the fuel pump module. The inlet door has a longitudinal body, a first and second pivot arm on opposing sides of the body for the door to pivot, a circular or semi-circular door portion having a through hole to secure a sealing member to the inlet door. The door portion and counterweight are at opposing ends of the body. When the inlet door rotates to its closed position, the sealing member creates a seal with the end of the jet tube. At least one straight peripheral edge about the otherwise curved door portion prevents the door portion from interfering with surrounding structure during operation.

### FIELD OF THE INVENTION

The present invention relates to fuel pump modules, and more specifically, to a counter-balanced inlet door of a fuel pump module check valve.

### BACKGROUND OF THE INVENTION

Automobiles commonly employ a fuel pump module within a fuel tank, the fuel pump module having a jet pump tube inlet door that acts in concert with a jet pump tube wall to form a check valve. Quite commonly, when the fuel pump module has voltage applied to it and the fuel tank has sufficient fuel, a fuel module jet pump at one end of the jet pump tube pumps the liquid fuel to force open the jet pump tube inlet door at the opposite end of the jet pump tube. The liquid fuel subsequently flows through the jet pump tube, opens the inlet door, and is then pumped to the engine to carry out combustion.

In some situations, however, the driver of a vehicle may allow the fuel level within the fuel tank to drop such that the vehicle “runs out of gas.” When this occurs, the fuel has been exhausted from the jet pump tube so that the jet pump will not assist in circulating fuel by opening the inlet door. Additionally, there is no fuel to surround the fuel pump module to provide hydrostatic force against the inlet door to open the inlet door of the jet pump tube. In this situation, even if voltage is applied to the fuel module, fuel is not able to open the jet pump tube inlet door and permit fuel to enter the jet pump tube. The consequence of this situation is that the vehicle is in need of a large quantity of fuel in the fuel tank to permit the inlet door of the jet pump tube to open so that fuel can fill the jet pump tube and be pumped to the engine when the fuel module is energized.

There are other situations when limitations present themselves. For instance, a situation in which the engine may not be capable of being restarted is when the level of fuel within the fuel tank drops to a particularly low level, but the tank is not empty, and there is no fuel in the jet pump tube. For instance, even when a vehicle is sitting on a level surface, there may not be enough fuel in the fuel tank to surround the fuel pump module inlet door and provide enough hydrostatic force against the inlet door to open it and permit fuel to enter the jet pump tube of the fuel pump module. In this situation, since the fuel in the jet pump tube has already been pumped to the engine, fuel is not capable of being supplied to the jet pump tube, even though there is a small amount of fuel in the fuel tank. The consequence of this is that the vehicle is in need of a larger quantity of fuel in the fuel tank to cause a greater hydrostatic force against the inlet door of the jet pump tube so that the inlet door will open and permit the jet pump tube to fill with fuel.

Another limitation exists when the fuel has been completely exhausted from the jet pump tube and the inlet door of the jet pump tube has closed, but there is fuel in the fuel tank; however, because the vehicle is not sitting on a level or nearly level surface, the distribution of the fuel in the fuel tank prevents the fuel from reaching or from sufficiently surrounding the jet pump tube inlet door and thus, from providing a hydrostatic force against the inlet door to open the inlet door and permit fuel to flow into the jet pump tube. In this situation, the engine is incapable of being restarted. To restart the engine, the vehicle must be repositioned to permit the fuel existing in the tank to surround the inlet door in such a quantity as to force open the inlet door.

In yet another limitation, a vehicle may run out of fuel while being driven resulting in the vehicle having to be refueled at the side of a road or wherever the vehicle is when it runs out of fuel. In this unplanned event, the vehicle may be stopped on a slanted shoulder, median or on uneven off-road terrain. In order to refuel the vehicle, one or two gallons of fuel may be carried to the vehicle in a portable container from a filling station. Because of the tilted position of the vehicle, the fuel is prevented from filling the jet pump tube due to the inability of the fuel to hydrostatically force open the jet pump tube inlet door that covers the jet pump tube inlet opening, which provides access to the fuel pump module. This inability of the fuel to reach the fuel pump module jet pump tube prevents fuel from being pumped to the engine and thus, the restarting of the engine. Although the fuel may be capable of reaching and even partially surrounding the jet pump tube inlet door, the level of fuel may not be high enough to effectively provide enough force against the inlet door to open it and permit fuel to enter the jet pump tube. A device of the prior art that suffers from the above limitations is depicted in FIGS. 9 and 10.

What is needed then is a device that does not suffer from the above limitations. This in turn, will provide a device that is capable of permitting additional liquid fuel to enter a jet pump tube, when an insufficient amount of fuel is present in the jet pump tube, by using hydrostatic force to cause a moment great enough about a door pivot point to open the jet pump tube inlet door. Furthermore, a device will be provided that permits liquid fuel to enter the fuel pump module jet pump tube when a vehicle and its fuel tank are positioned at an angle with respect to a surface on which the vehicle is sitting and hydrostatically force open the jet pump tube inlet door. In all events, the jet pump tube inlet door will be forced open when a minimum amount of fuel is introduced into the fuel tank when the vehicle is positioned on a level surface or at an angle to the surface on which the vehicle is sitting.

### SUMMARY OF THE INVENTION

In accordance with the teachings of the present invention, a fuel pump module check valve inlet door that permits liquid fuel to enter the jet pump tube when a prescribed minimum amount of liquid fuel is poured into a vehicle's empty, or nearly empty, tank is disclosed. Additionally, the fuel pump module check valve inlet door will be counter-balanced to assist the hydrostatic force of the fuel in creating a moment to open the jet pump tube inlet door when the fuel level in the tank is at a minimum. Furthermore, the fuel pump module counter-balanced inlet door will be buoyed by the liquid fuel being poured into the tank to supplement the moment to open the inlet door and permit the passage of fuel into the jet pump tube. Finally, the fuel pump module counter-balanced inlet door will permit fuel to enter the jet pump tube even when a vehicle employing the counter-balanced inlet door is parked on a sloped surface such as a shoulder of a road.

In one preferred embodiment, the fuel pump module check valve inlet door has an elongated body, a first pivot arm and a second pivot arm attached to the body to permit rotation about the arms, a door portion attached to a first end of the body and a counterweight attached to the opposite end of the body. The door portion in this first preferred embodiment is semi-circular with straight edges about its periphery. In a second preferred embodiment, the fuel pump module check valve inlet door is essentially circular. In each embodiment, a door seal abuts a wall surface to create the check valve.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a vehicle showing the location of a fuel tank within the vehicle and a fuel module within the fuel tank, according to teachings of the present invention;

FIG. 2 is a perspective view of the fuel module depicted in FIG. 1, according to teachings of the present invention;

FIG. 3 is a perspective view of the fuel tank depicted in FIG. 1, showing the location of the fuel module in the fuel tank;

FIG. 4 is a rear view of the vehicle depicted in FIG. 1 showing the location of the fuel pump module inlet door relative to the fuel level within the fuel tank when the vehicle is positioned on a slope, according to teachings of the present invention;

FIG. 5 is a perspective view of the counter-balanced inlet door of the fuel pump module check valve, according to teachings of a first preferred embodiment of the present invention;

FIG. 6 is a perspective view of the counter-balanced inlet door of the fuel pump module check valve according to teachings of a second preferred embodiment of the present invention;

FIG. 7 is a partial cross-sectional view of the fuel pump module check valve showing the counter-balanced inlet door in a closed position according to teachings of the present invention;

FIG. 8 is a partial cross-sectional view of the fuel pump module check valve showing the counter-balanced inlet door in an open position according to teachings of the present invention;

FIG. 9 is a perspective view of the fuel pump module reservoir depicting the location of the fuel pump module check valve according to teachings of the present invention;

FIG. 10 is a perspective view of a fuel pump module check valve inlet door of the prior art; and

FIG. 11 is a partial cross-sectional view of the fuel pump module check valve and inlet door of the prior art.

### DETAILED DESCRIPTION OF THE PREFERRED EMBODIMENT

The following description of the preferred embodiment is merely exemplary in nature and is in no way intended to limit the invention, its application, or uses. With reference to FIGS. 1-9, description of a counter-balanced inlet door and associated check valve for a fuel pump module will be described.

FIG. 1 depicts a vehicle such as an automobile 10 in which a fuel pump module 20 is installed within a fuel tank 30 of the automobile 10. In this arrangement, the fuel pump module 20 is normally submerged in or surrounded by liquid fuel within the fuel tank 30 when the fuel tank 30 possesses liquid fuel. The fuel pump module 20 pumps fuel to the engine 12 via a fuel line 14.

FIG. 2 is a perspective view of the fuel pump module 20 having a reservoir 22 in which a fuel inlet 24 is located at one of its corners. The fuel module 20 is normally installed such that the top of the fuel module 20 is exposed outside of the top of the fuel tank 30 and the balance of the fuel module 20 is positioned within the fuel tank 30. The fuel inlet 24 into the reservoir 22 is located on a side at the bottom of the reservoir 22 and permits fluid communication between the fuel module 20 and liquid fuel located outside of the reservoir 22 at the bottom of the fuel tank 30. Because of the location of the fuel inlet 24 relative to the bottom of the fuel tank 30, fuel is capable of entering the reservoir 22 when the fuel level is at a low level within the fuel tank 30.

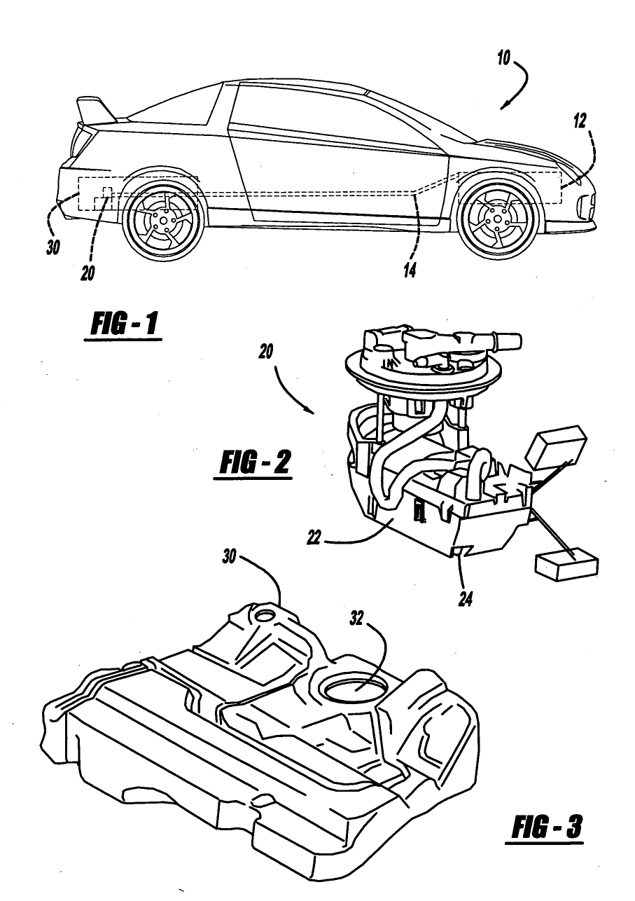

FIG. 3 is an example of the fuel tank 30, indicating as a void, the location 32 that the fuel pump module 20 occupies when the fuel pump module 20 is installed in the fuel tank 30. The location of the fuel pump module 20 may vary within the fuel tank 30 depending upon the geometry of the fuel tank 30, the depth of the fuel pump module 20, and other factors.

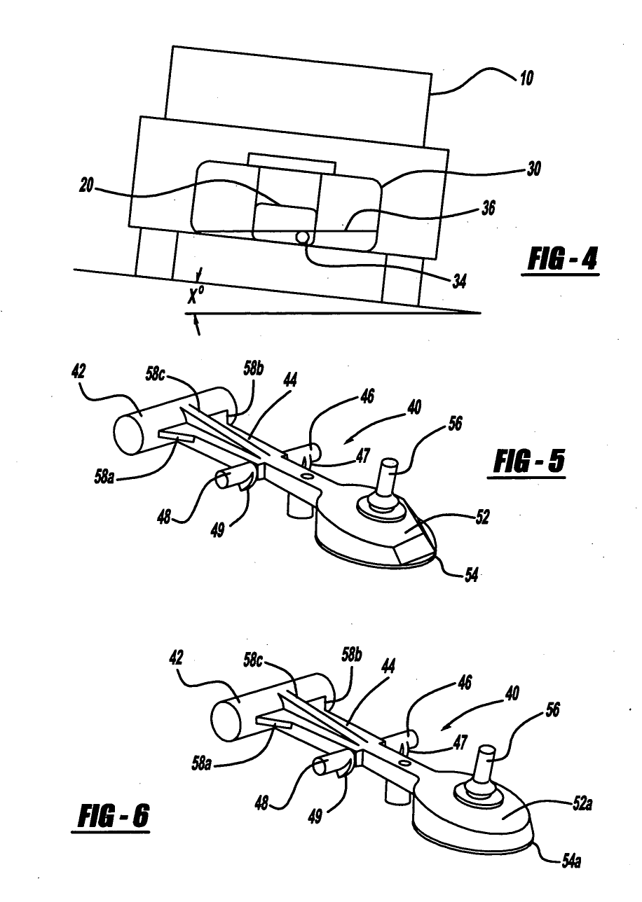

FIG. 4 depicts a rear view of the automobile 10 shown in FIG. 1 and shows the fuel pump module 20 installed within the fuel tank 30. Additionally, the cross-section of the inlet 34 of the fuel pump module 20 is shown below the level of liquid fuel 36 in the fuel tank 30. As depicted in FIG. 4, the inlet 34 is entirely submerged ender the liquid fuel level 36 at the same time that the vehicle 10 is shown parked at an angle noted by “X” degrees. The angle X may range from zero (0) degrees to four (4) degrees (7% slope), or actually, to an even higher degree (greater slope) and still achieve the desired submergence of the inlet 34 below the liquid fuel level 36. The actual angle depends upon how the fuel pump module 20 is situated in the fuel tank, the design of the fuel tank 30, the level of fuel in the fuel tank 30, and associated variables.

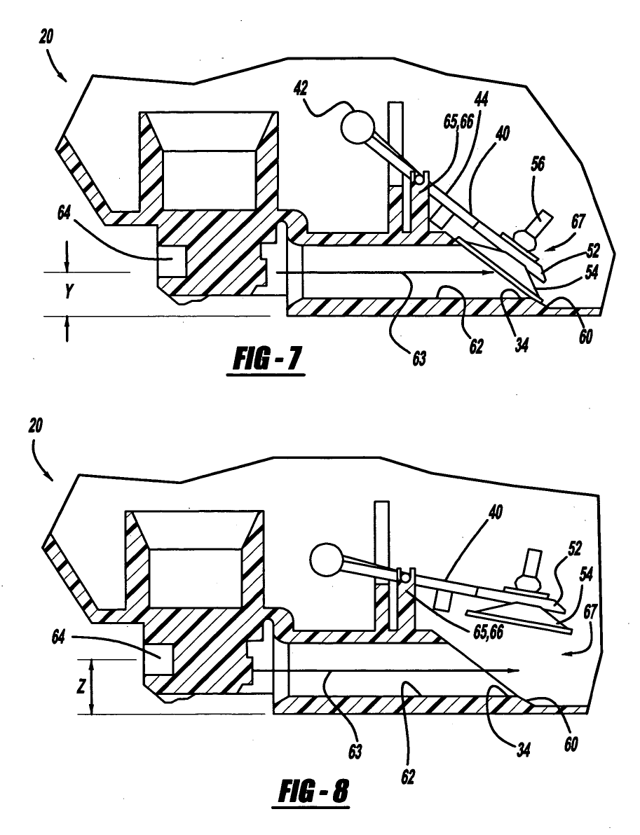

Turning to FIGS. 5, 7 and 8, an example of the counter-balanced inlet door 40 for a fuel pump module 20 check valve 67, according to the teachings of the first embodiment will be described. FIG. 5 depicts the counter-balanced inlet door 40 of the first embodiment, while FIGS. 7 and 8 depict closed and open positions, respectively, of the inlet door 40 and check valve 67. The counter-balanced inlet door 40 has a door portion 52 that abuts against a jet pump tube sealing surface 60 of the jet pump tube 62 when the counter-balanced inlet door 40 is in its closed position. A resilient door seal 54 is fastened to the door portion 52 by a resilient fastening portion 56 of the door seal 54. The resilient door seal 54 and the resilient fastening portion 56 are one piece in the present embodiment and are made from the same material. The door seal 54 and resilient fastening portion 56 are normally manufactured from a flexible material such as rubber that is capable of compressing and sealing against the jet pump tube sealing surface 60. However, the door seal 54 may be made of any material capable of forming a seal with the jet pump tube sealing surface 60 and of existing in a liquid fuel environment. The liquid fuels are normally grades of gasoline, but may include diesel fuel or other fuels such as kerosene. The door portion 52 in the present embodiment is made of a plastic that is capable of existing in a liquid fuel environment, but the door portion 52 may be made of a lightweight metal or other non-plastic material.

Maintaining reference to FIGS. 5 and 7, the door seal 54 abuts against the jet pump tube sealing surface 60 when the counter-balanced inlet door 40 is in its closed position. The fastening portion 56 passes through the door portion 52 in order to secure the door seal 54 to the door portion 52. The door portion 52 is connected to a door body 44. The door body 44 has several web portions 58a, 58b, 58c that provide strength to the body 44. At the end opposite to the door portion 52, a counterweight 42 is attached. The counterweight 42 is a weight that counters the weight of the door portion 52 with respect to pivot posts 65, 66 of the jet pump tube 62. The entire counter-balanced inlet door 40 has a first pivot arm 46 having a first pivot pad 47, and a second pivot arm 48 having a second pivot pad 49. The pivot arms 46, 48 snap and lock into the pivot posts 65, 66 extending from the jet pump tube 62 of the fuel pump module 20. The first pivot arm 46 and the second pivot arm 48 pivot upon the pivot posts 65, 66 to permit the opening and closing of the check valve 67 formed by the counter-balanced inlet door 40 and the jet pump tube sealing surface 60. With reference to FIG. 8, the door seal 54 moves away from the sealing surface 60 when the door opens. This is caused by the rotation of the inlet door 40 pivot arms 46, 48 when the arms rotate within the pivot posts 65, 66.

FIG. 6 depicts the counter-balanced inlet door 40 for a fuel pump module 20 check valve 67, according to the teachings of a second embodiment, which will now be described. The difference between the inlet door 40 of the first embodiment of FIG. 5 and the inlet door 40 of the second embodiment of FIG. 6, is in the respective door portions, 52 and 52a. In FIG. 6, the door portion 52a is circular, while in FIG. 5, the door portion 52 has straight edges in its periphery. Depending upon the operative workings of the check valve 67, the straight edges of the door portion 52 may be necessary to provide clearance from other parts of the check valve 67.

Before the operative workings of the embodiments is described, additional components related to the operation of the check valve 67 will be described. The fuel pump module 20 also has a jet pump 64 which pumps the liquid fuel of the fuel module 20 through the jet pump tube 62 and into the door portion 52 when the engine 12 is running or at least when the fuel pump module 20 is energized. When the fuel pump module is not energized, the fuel rises in the jet pump tube 62, causing a resulting force of the pressure against the door seal 54 and door portion 52. This force causes the counter-balanced inlet door 40 arms 46, 48 to pivot upon the pivot posts 65, 66, open the inlet door 40 (FIG. 8), and permit liquid fuel to flow into the jet pump tube 62 from the reservoir 22.

Now, a more detailed description of the operative workings of the counter-balanced inlet door 40 of the fuel pump module check valve 67 will be provided. Normally, when a vehicle fuel tank 30 possesses enough fuel to completely submerge the fuel pump module 20, or at least engulf the jet pump tube 62, the fuel easily flows from the fuel tank 30 into the fuel pump module 20 via the open inlet door 40 of the jet pump tube 62, in order to provide fuel to the fuel pump module 20 and subsequently, to the engine 12 via fuel line 14. This flowing of fuel is made possible because the counter-balanced inlet door 40 opens due to the force caused by the jet pump 64 forcing a stream of fuel 63 against the inside surface of the door portion 52 and door seal 54. This is the normal operation when the engine is running; however, the embodiments of the present invention are capable of opening the check valve 67 when the engine is not running, that is, in order to get fuel into the jet pump tube 62, when just a small amount of fuel is poured into an empty fuel tank 30 in order to re-start the vehicle engine 12.

An example of how the teachings of the present invention may be employed will now be explained. When a driver drives his car to the point that it runs out of fuel, he or she will normally pull over to the shoulder of the road on which the car is being driven. At this point, the driver will then need to put fuel into the fuel tank to restart the engine. This may mean that as little as one gallon of fuel will be carried from a filling station to be placed into the vehicle.

When the vehicle runs out of fuel, it is a result of all of the fuel in the fuel tank 30 and the fuel pump module 20, including the jet pump tube 62, from being pumped to the engine 12. This means that since the jet pump 64 has stopped pumping fuel through the jet pump tube 62, which normally causes the inlet door 40 to remain open, the inlet door 40 closes. In order for the gallon of fuel, which the vehicle operator places into the fuel tank, to gain entry into the jet pump tube 62, the fuel level must be at a level capable of creating a force against the interior of the inlet door 40 large enough to cause a moment large enough to rotate, and hence lift, the inlet door 40 of the jet pump tube 62. This is a rotation of the inlet door 40 in FIGS. 7 and 8. When the inlet door 40 opens, causing fuel to enter the jet pump tube 62, the jet pump 64 will eventually begin to pump again, and thus, keep the inlet door 40 open. The inlet door 40 will remain open as long as there is fuel for the jet pump 64 to pump. The reason the inlet door 40 is permitted to close is to retain the liquid fuel within the jet pump tube 62 to restart the engine after the engine is shut off. That is, the fuel pump module 20 and engine 12 rely on the fuel in the jet pump tube 62 for restarting, so the inlet door 40 closes to retain this fuel.

As depicted in FIG. 4, the angle X of the shoulder plays a role in determining how much fuel is necessary to be put into the tank in order to open the jet pump tube 62 inlet door 40. This was taken into consideration in the present embodiment. For instance, the teachings of the present embodiment take into consideration the fact that the greater the slope of the road shoulder, the greater the volume of fuel that must be poured into the fuel tank so that the fuel will rise high enough to not only make contact with the inlet door 40, but place enough hydrostatic force against it to cause it to rotate and open. For the present preferred embodiment, the angle X is 4 degrees, which is a 7 percent slope.

When the level of fuel in the fuel tank is so low, or empty, that starting the engine is not possible, the fuel level must be brought above the level “Y” indicated in FIG. 7. At the level “Y” the inlet door 40 will not yet open; however, at the level “Z” noted in FIG. 8, the inlet door 40 opens due to the hydrostatic force placed on the door by the pressure of the fuel when the vehicle is refueled with a gallon of fuel, or more, at the side of a road. That is, the level of fuel from one gallon of fuel is high enough to cause a great enough pressure, resulting force and moment about the pivot point of pivot arms 46, 48 to cause the inlet door 40 to open and fuel to enter the jet pump tube 62. This opening is accomplished with the assistance of the counterweight 42 and the resulting moment about the pivot point of pivot arms 46, 48 of the inlet door 40, since their moments act in the same direction.

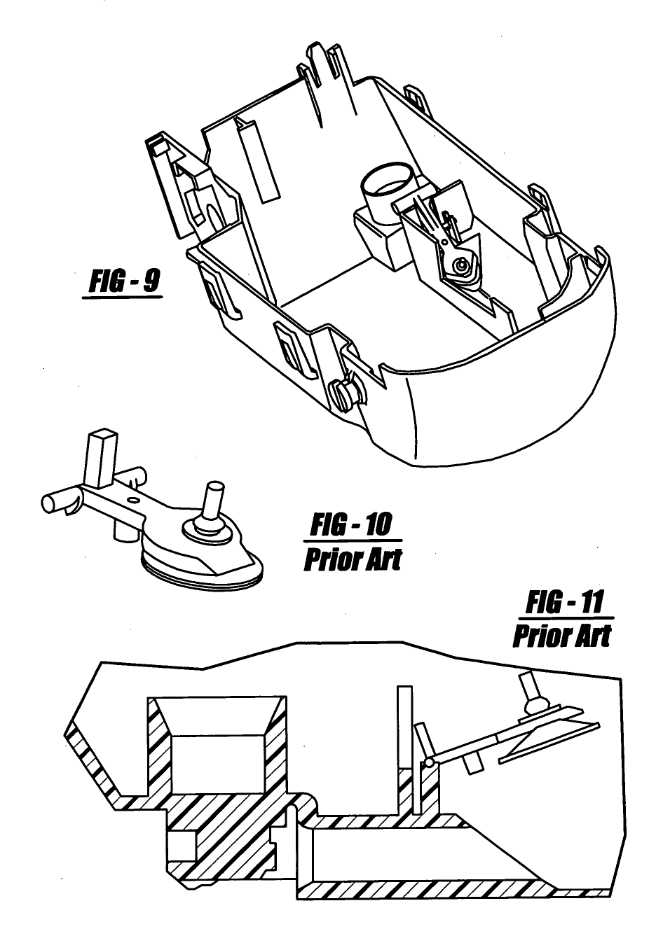

To the contrary, the opening of the inlet door is not possible with the prior art door of FIGS. 10 and 11 under the same conditions. That is, after a vehicle has run out of fuel, and the level of fuel is brought to the level “Z” of FIG. 8, the inlet door of the prior art of FIGS. 10 and 11 is not capable of opening by the hydrostatic force of the liquid fuel against the door portion of the inlet door. The level of fuel must be much higher than the level “Z” of FIG. 8. That is, the force against the door portion of the inlet door is not great enough to cause a large enough moment to open the inlet door until the level is much higher than the level “Z” of FIG. 8 for the prior art door of FIGS. 10 and 11.

Therefore, the counter-balanced inlet door 40 and the jet pump tube sealing surface 60 of the fuel pump module 20 form a check valve 67 that is a one-way valve that prevents fuel from exiting the jet pump tube 62 after the fuel level in the fuel tank 30 has dropped to a particular level, such as the height Y in FIG. 7. The reason the counter-balanced inlet door 40 closes when the fuel pump module 20 is de-energized, is to prevent fuel from flowing out of reservoir 22. This permits fuel to remain in the module 20 at all times, even when the fuel pump module 20 is not operating and the fuel level is below level Z of FIG. 8. When the fuel pump module reservoir 22 is filled with fuel and the fuel pump module 20 within the fuel pump reservoir 22 is surrounded with fuel, the engine 12 can easily be restarted because there is a plentiful supply of fuel available to the fuel pump module 20.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel pump module inlet door comprising:
a body;
a first pivot arm and a second pivot arm attached to said body;
a door portion attached to a first end of said body; and
a counterweight adapted to said body at an opposite end as said door portion.

2. The fuel pump module inlet door of claim 1, further comprising:
structural webbing located between said counterweight and said body.

3. The fuel pump module inlet door of claim 1, further comprising:
a first pivot pad located on said first pivot arm.

4. The fuel pump module inlet door of claim 3, further comprising:
a second pivot pad located on said second pivot arm.

5. The fuel pump module inlet door of claim 1, further comprising:
a flexible seal adapted to said door portion.

6. The fuel pump module inlet of claim 5, wherein said door portion defines a hole such that a fastening portion of said flexible seal passes through said hole to secure said seal to said door portion.

7. The fuel pump module inlet door of claim 1, wherein said door portion has a beveled surface.

8. The fuel pump module inlet door of claim 1, wherein said door portion has a first and a second beveled surface.

9. A fuel pump module check valve comprising:
a central body having a first pivot arm and a second pivot arm; and
a counterweight located at an opposite end of said central body as a door covering portion, wherein the door covering portion has a flexible seal adapted to it to abut against the end surface of a tube.

10. The fuel pump module check valve of claim 9, further comprising:
a plurality of pivot posts adapted to said tube, said first pivot arm and said second pivot arm adapted to rotate on said pivot posts.

11. The fuel pump module check valve of claim 10, wherein said flexible seal is adapted through said door covering portion and seals against said end surface when said door covering portion is pivotably closed against said end surface.

12. The fuel pump module check valve of claim 11, wherein said door covering portion defines a hole through which a portion of said seal passes to secure said seal to said door covering portion.

13. In a vehicle having a fuel pump module within a vehicle fuel tank, an apparatus for controlling the flow of fuel comprising:
a longitudinal body;
a first pivot arm and a second pivot arm, said pivot arms attached on opposing sides of said longitudinal body;
a door portion having a through hole and attached to a first end of said longitudinal body;
a counterweight attached to a second end of said longitudinal body, said counterweight at an opposite end as said door portion;
a plurality of counterweight support portions bridging said counterweight and said longitudinal body;
a seal abutting the face of the door portion and passing through said door portion to secure said seal to said door portion.

14. The apparatus of claim 13, further comprising:
a tube having an end surface such that said seal of said door portion abuts against said end surface when said door portion rests against said end surface.

15. The apparatus of claim 14, further comprising:
a beveled surface on said door portion.

16. The apparatus of claim 15, further comprising:
at least one straight peripheral edge along a periphery of said door portion.

17. The apparatus of claim 13, further comprising:
a first pivot pad located on said first pivot arm; and
a second pivot pad located on said second pivot arm, wherein said pivot pads contact said pivot posts when said door portion rotates.

18. The apparatus of claim 13, wherein said door portion is circular.

19. The apparatus of claim 13, wherein said longitudinal body has a smaller cross-section adjacent the door portion than adjacent the counterweight.
